(19) United States
(12) Patent Application Publication
(10) Pub. No.: US 2022/0198846 A1
(43) Pub. Date: Jun. 23, 2022

(54) METHOD FOR CONTROLLING DATA COLLECTION, ELECTRONIC DEVICE, AND MEDIUM

(71) Applicant: BEIJING BAIDU NETCOM SCIENCE TECHNOLOGY CO., LTD., Beijing (CN)

(72) Inventors: Kuang HU, BEIJING (CN); Xitong WANG, BEIJING (CN); Jie ZHOU, BEIJING (CN); Songhong CHANG, BEIJING (CN); Chao MA, BEIJING (CN); Jin LI, BEIJING (CN); Xiao WEI, BEIJING (CN)

(21) Appl. No.: 17/691,903

(22) Filed: Mar. 10, 2022

(30) Foreign Application Priority Data
Mar. 26, 2021 (CN) 202110325806.8

(51) Int. Cl. G07C 5/08

(52) U.S. Cl. CPC G07C 5/0841

(57) ABSTRACT

A method is provided that includes: acquiring environmental data of a current environment in which a vehicle is located; determining, according to the environmental data, that the current environment meets an environment collection requirement; in response to the determining, controlling one or more collection devices of the vehicle to perform data collection according to a current production flow of the vehicle, the one or more collection devices correspond to the current production flow; and controlling the data collection of the one or more collection devices based on a data collection situation of the one or more collection devices.

### CROSS-REFERENCE TO RELATED APPLICATIONS

This application claims priority to Chinese patent application No. 202110325806.8, filed on Mar. 26, 2021, the contents of which are hereby incorporated by reference in their entirety for all purposes.

### TECHNICAL FIELD

The present disclosure relates to the technical field of vehicles, and particularly relates to the technical field of automatic driving and vehicle detection. The present disclosure specifically relates to a method, an electronic device, and a storage medium for controlling data collection.

### BACKGROUND

Automatic driving technology can involve many aspects such as environment perception, behavior decision making, path planning, and motion control. Relying on the collaboration of artificial intelligence, visual computing, radar, a monitoring apparatus, and a global positioning system, automatic driving vehicles can run automatically and safely without a driver's active operation.

### SUMMARY

According to an aspect of the present disclosure, a method is provided that includes: acquiring environmental data of a current environment in which a vehicle is located; determining, according to the environmental data, that the current environment meets an environment collection requirement; in response to the determining, controlling one or more collection devices of the vehicle to perform data collection according to a current production flow of the vehicle, wherein the one or more collection devices correspond to the current production flow; and controlling the data collection of the one or more collection devices based on a data collection situation of the one or more collection devices.

According to an aspect of the present disclosure, an electronic device is provided that includes: a processor; and a memory communicatively connected to the processor, wherein the memory stores a computer program executable by the processor, wherein the computer program, when executed by the processor, is configured to cause the electronic device to perform operations including: acquiring environmental data of a current environment in which a vehicle is located; determining, according to the environmental data, that the current environment meets an environment collection requirement; in response to the determining, controlling one or more collection devices of the vehicle to perform data collection according to a current production flow of the vehicle, wherein the one or more collection devices correspond to the current production flow; and controlling the data collection of the one or more collection devices based on a data collection situation of the one or more collection devices.

According to an aspect of the present disclosure, a non-transitory computer-readable storage medium that stores a computer program is provided that, when executed by a processor of a computer, causes the computer to perform operations including: acquiring environmental data of a current environment in which a vehicle is located; determining, according to the environmental data, that the current environment meets an environment collection requirement; in response to the determining, controlling one or more collection devices of the vehicle to perform data collection according to a current production flow of the vehicle, wherein the one or more collection devices correspond to the current production flow; and controlling the data collection of the one or more collection devices based on a data collection situation of the one or more collection devices.

### BRIEF DESCRIPTION OF THE DRAWINGS

The accompanying drawings illustrate the embodiments and constitute one part of the description, and are intended to explain example implementations of the embodiments together with text descriptions of the description. The embodiments shown are for the purpose of illustration only, and are not intended to limit the scope of claims. In all the drawings, identical reference signs refer to similar but not identical elements.

FIG. 1 illustrates a schematic diagram of an example system, in which various methods described herein can be implemented, according to the embodiments of the present disclosure;

FIG. 2 illustrates a flowchart of a method for controlling data collection according to the embodiments of the present disclosure;

FIG. 3 illustrates a schematic diagram of an environment collection and configuration generation system according to the embodiments of the present disclosure;

FIG. 4 illustrates a schematic flowchart of an environment collection and configuration generation method according to the embodiments of the present disclosure;

FIG. 5 illustrates a structural block diagram of an apparatus for controlling data collection according to the embodiments of the present disclosure; and

FIG. 6 illustrates a structural block diagram of an electronic device of an example server and a client that can be used for realizing the embodiments of the present disclosure.

### DETAILED DESCRIPTION

In the present disclosure, unless otherwise specified, use of terms “first”, “second”, etc. to describe various elements is not intended to limit the positional relationship, timing relationship, or importance relationship of these elements. Such terms are only used for distinguishing one element from another. In some examples, a first element and a second element may refer to the same instance of the element, and in some cases, they may also refer to different instances based on the description of the context.

The terms used in the description of the various examples in the present disclosure are for the purpose of describing specific examples only, and are not intended for limitation. Unless the context clearly indicates otherwise, if the number of elements is not specifically limited, there may be one or more elements. In addition, the term “and/or” used in the present disclosure covers any one of the listed items and all possible combinations.

Before being put into use, an automatic driving vehicle needs to go through a series of production processes. Generally, in order to complete a series of production processes for the automatic driving vehicle, it is required to establish a professional calibration room and professional collection vehicles for related work. This method provides higher production efficiency for large-scale production. However, this method also requires high-cost professional devices and relatively professional technical personnel that small companies in the initial stage of automatic driving/or development teams for scientific research and teaching purposes cannot afford.

Hence, the present disclosure provides a method for controlling data collection, the dependence on a high-cost professional site, professional devices and professionals can be reduced by automatically analyzing and determining a current test environment and collected data, so as to reduce the cost on human and material resources. The embodiments of the present disclosure is described in detail below in conjunction with the accompanying drawings.

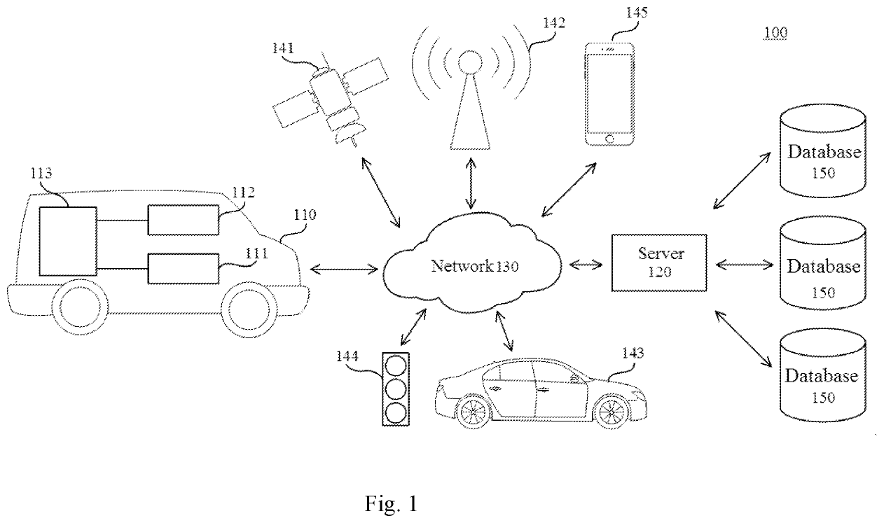

FIG. 1 illustrates a schematic diagram of an example system 100, in which various methods and apparatuses described herein can be implemented, according to the embodiments of the present disclosure. Referring to FIG. 1, the system 100 includes a motor vehicle 110, a server 120, and one or more communication networks 130 for connecting the motor vehicle 110 to the server 120.

In some embodiments, the server 120 may also provide other services or software applications that may include non-virtual environments and virtual environments. In the configuration shown in FIG. 1, the server 120 may include one or more components that realize a function executed by the server 120. These components may include a software component, a hardware component, or a combination thereof executed by one or more processors. A user of the motor vehicle 110 can use one or more client application programs in sequence to interact with the server 120 to use services supplied by these components. It should be understood that various different system configurations are possible, and may be different from the system 100. Therefore, FIG. 1 is one example of a system used for implementing various methods described herein, and is not intended for limitation.

The server 120 may include one or more general-purpose computers, dedicated server computers (for example, personal computer (PC) servers, UNIX servers, and mid-range servers), blade servers, mainframe computers, server clusters, or any other suitable arrangement and/or combination. The server 120 may include one or more virtual machines running a virtual operating system, or other computing architectures involving virtualization (for example, one or more flexible pools of logical storage devices that may be virtualized to maintain virtual storage devices of a server). In various embodiments, the server 120 may run one or more services or software applications that provide the functions described below.

A computing unit in the server 120 may run one or more operating systems including any of the above-mentioned operating systems and any commercially available server operating systems. The server 120 may also run any one of various additional server application programs and/or middle-tier application programs, including an HTTP server, an FTP server, a CGI server, a JAVA server, a database server, etc.

In some implementation modes, the server 120 may include one or more application programs to analyze and merge data feedbacks and/or event updates received from the motor vehicle 110. The server 120 may also include one or more application programs to display data feedbacks and/or real-time events via one or more display devices of the motor vehicle 110.

In some implementation modes, the server 120 can be a server of a distributed system or a server combined with a blockchain. The server 120 can also be a cloud server, or a smart cloud computing server or smart cloud host with an artificial intelligence technology. A cloud server is a host product in the cloud computing service system to overcome the shortcomings of difficult management and weak business scalability in traditional physical host and virtual private server (VPS) services.

The network 130 may be any type of network well known to those skilled in the art, and may use any one of a variety of available protocols (including but not limited to TCP/IP, SNA, IPX, etc.) to support data communication. As an example only, the one or more networks 130 may be a local area network (LAN), an Ethernet-based network, a token ring, a wide area network (WAN), an Internet, a virtual network, a virtual private network (VPN), an intranet, an extranet, a public switched telephone network (PSTN), an infrared network, a wireless network (such as Bluetooth™, Wi-Fi) and/or any combination of these networks and/or other networks.

The system 100 may also include one or more databases 150. In some embodiments, these databases can be used to store data and other information. For example, one or more of the databases 150 may be used to store information such as audio files and video files. The databases 150 may reside in various positions. For example, a database used by the server 120 may be local to the server 120, or may be away from the server 120 and may be in communication with the server 120 via a network-based or dedicated connection. The databases 150 may be of different types. In some embodiments, the databases used by the server 120 may be relational databases. One or more of these databases can store, update, and retrieve data to and from the databases in response to a command.

In some embodiments, one or more of the databases 150 may also be used by application programs to store application program data. The databases used by the application programs can be different types of databases, such as a key-value repository, an object repository, or a regular repository supported by a file system.

The motor vehicle 110 may include a sensor 111 used to sense a surrounding environment. The sensor 111 may include one or more of the following sensors: a vision camera, an infrared camera, an ultrasonic sensor, a millimeter wave radar, and a laser radar (LiDAR). Different sensors can provide different detection accuracies and ranges. The camera can be installed in the front, rear or other positions of the vehicle. The vision camera can capture the situations inside and outside the vehicle in real time and present them to the driver and/or passengers. In addition, by analyzing images captured by the vision camera, information such as traffic light indications, intersection conditions, and operating states of other vehicles can be acquired. The infrared camera can capture objects under night vision. The ultrasonic sensor can be installed around the vehicle and used to measure a distance between an object outside the vehicle and the vehicle by using the characteristic of strong directionality of ultrasonic waves. The millimeter wave radar can be installed in the front, rear or other positions of the vehicle and used to measure the distance between the object outside the vehicle and the vehicle by using the characteristics of electromagnetic waves. The LiDAR can be installed in the front, rear or other positions of the vehicle and used to detect edge and shape information of the object for object recognition and tracking. Due to the Doppler effect, a radar device can also measure speed changes of the vehicle and a moving object.

The motor vehicle 110 may also include a communication apparatus 112. The communication apparatus 112 may include a satellite positioning module capable of receiving satellite positioning signals (such as Beidou, GPS, GLONASS, and GALILEO) from a satellite 141 and generating coordinates based on these signals. The communication apparatus 112 may also include a module for communicating with a mobile communication base station 142. The mobile communication network may implement any suitable communication technology, such as GSM/GPRS, CDMA, LTE and other current or evolving wireless communication technologies (such as a 5G technology). The communication apparatus 112 may also have Internet of vehicles or a vehicle-to-everything (V2X) module, configured to implement vehicle-to-outside communication such as vehicle-to-vehicle (V2V) communication with other vehicles 143, and vehicle-to-infrastructure (V2I) communication with an infrastructure 144. In addition, the communication apparatus 112 may also have a module configured to be in communication with a user terminal 145 (including but not limited to a smart phone, a tablet computer, or a wearable apparatus such as a watch) through a wireless local area network or Bluetooth using the IEEE 802.11 standard, for example. By using the communication apparatus 112, the motor vehicle 110 can also access the server 120 via a network 130.

The motor vehicle 110 may also include a control apparatus 113. The control apparatus 113 may include a processor that is in communication with various types of computer-readable storage apparatuses or media, such as a central processing unit (CPU) or a graphics processing unit (GPU), or other dedicated processors. The control apparatus 113 may include an automatic driving system used to automatically control various actuators in the vehicle. The automatic driving system is configured to control a powertrain, a steering system, and a brake system of the motor vehicle 110 (not shown) in response to inputs from a plurality of sensors 111 or other input devices via a plurality of actuators to respectively control acceleration, steering and braking without human intervention or limited human intervention. Part of processing functions of the control apparatus 113 can be implemented through cloud computing. For example, an on-board processor can be used to perform certain processing, while computing resources of the cloud can be used to perform other processing. The control apparatus 113 may be configured to execute the method according to the present disclosure. In addition, the control apparatus 113 may be implemented as an example of an electronic device on a motor vehicle side (a client side) according to the present disclosure.

The system 100 of FIG. 1 may be configured and operated in various ways to apply various methods and apparatuses described according to the present disclosure.

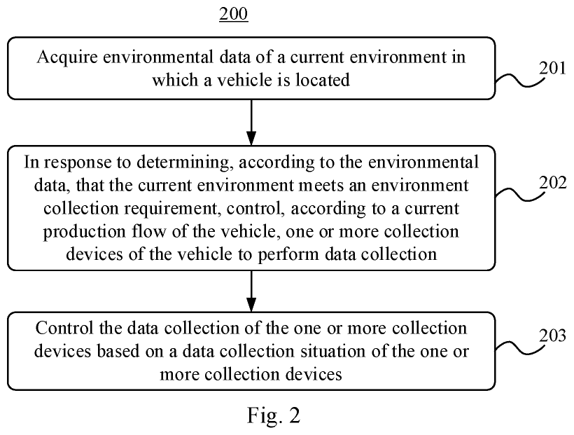

FIG. 2 illustrates a flowchart of a method 200 for controlling data collection according to the embodiments of the present disclosure. As shown in FIG. 2, the method 200 may include the following steps.

In step 201, environmental data of a current environment in which a vehicle is located is acquired.

In step 202, in response to determining, according to the environmental data, that the current environment meets an environment collection requirement, one or more collection devices of the vehicle are controlled, according to a current production flow of the vehicle, to perform data collection.

In some embodiments, the one or more collection devices of the vehicle may correspond to the current production flow of the vehicle. For example, different collection devices of the vehicle are respectively controlled, according to the current production flow of the vehicle, to be turned on, so as to perform the corresponding data collection.

In step 203, data collection of the one or more collection devices is controlled based on a data collection situation of the one or more collection devices.

Therefore, under the condition that the current environment meets the environment collection requirement, the one or more collection devices of the vehicle are controlled, according to the current production flow, to perform the data collection, and the data collection is controlled according to the data collection situation of the one or more collection devices. Therefore, automatic detection of the current test environment and collected data can be realized, the dependence on a high-cost professional site, professional devices and professionals is reduced, so as to reduce the cost on human and material resources.

In some embodiments, the environmental data of the current environment where the vehicle is located may be acquired, and whether the environment collection requirement is currently met is determined according to the environmental data. Under the condition that the environment collection requirement is met, each collection device of the vehicle is then controlled to perform the data collection.

In some examples, the current production flow may include, for example, vehicle calibration, vehicle sensing device calibration, vehicle map collection, etc. In some embodiments, a vehicle sensing device may include, for example, a vision camera, an infrared camera, an ultrasonic sensor, a millimeter wave radar, a LiDAR, etc. The vehicle sensing device calibration may include, for example, LiDAR-inertial measurement unit (LiDAR-IMU) calibration, LiDAR-camera calibration, etc.

Different production flows may have different requirements for a collection environment. In some examples, the current environment may be determined by analyzing point cloud data, positioning data, etc. In some embodiments, for the LiDAR-IMU calibration, the environment collection requirement may include, for example, that a distance between an obstacle around a collection region and the vehicle needs to be within a predetermined range, the obstacle needs to be stationary, the obstacle needs to have edge bulges in a certain ratio, the floor of the collection region needs to be flat, etc. For the LiDAR-camera calibration, the environment collection requirement may include, for example, that an obstacle needs to be stationary, the obstacle needs to have edge bulges in a certain ratio, the floor of the collection region needs to be flat, etc. For the vehicle calibration, the environment collection requirement may include, for example, that the floor of the collection region needs to be flat.

In some embodiments, when determining whether the current environment meets the environment collection requirement, configuration information of the vehicle and the current production flow of the vehicle are also considered in a combined manner. The configuration information of the vehicle may include, for example, a high-definition map, a vehicle calibration table, a sensing device calibration table, vehicle sensing device solution configuration, automatic driving software system parameter configuration, etc. Whether the data collection is performed in the current environment where the vehicle is located (i.e., the environment collection requirement is met) may be determined according to the configuration information of the vehicle, the current production flow (such as the vehicle calibration, the sensing device calibration, and the map collection) and the collected environmental data.

In some embodiments, the collection devices of the vehicle may include, for example, a navigation device (such as an integrated inertial navigation device: a global navigation satellite system (GNSS)+IMU), a positioning module, a LiDAR device, a camera (such as a vision camera and an infrared camera), and the like. In some embodiments, controlling the collection devices of the vehicle to perform data collection may refer to turning on the collection devices and opening corresponding data channels of the collection devices to perform the data collection.

For different production flows, the collection devices to be turned on are also different. In some embodiments, for the LiDAR-IMU calibration, the following needs to be turned on: the integrated inertial navigation device and its corresponding data channel, the positioning module and its corresponding data channel, the LiDAR device and its corresponding data channel, etc. For the LiDAR-camera calibration, the following needs to be turned on: the integrated inertial navigation device and its corresponding data channel, the positioning module and its corresponding data channel, the LiDAR device and its corresponding data channel, the camera device and its corresponding data channel, etc. For the vehicle calibration, the following needs to be turned on: the integrated inertial navigation device and its corresponding data channel, the positioning module and its corresponding data channel, a vehicle chassis communication module and its corresponding data channel, etc. For the vehicle map collection, the following needs to be turned on: the integrated inertial navigation device and its corresponding data channel, the positioning module and its corresponding data channel, the vehicle chassis communication module and its corresponding data channel, the LiDAR device and its corresponding data channel, the camera device and its corresponding data channel, etc.

In some embodiments, controlling the data collection of the collection devices may include, for example, controlling the collection devices to continue to perform or to stop the data collection. In some embodiments, when it is determined that the data collection of the one or more collection devices meets a condition, the one or more collection devices may be controlled to stop the data collection. In some embodiments, the condition may include at least one of a first sub condition or a second sub condition. The first sub condition may be that a first collection device in the one or more collection devices does not collect data. The second sub condition may be that data collected by a second collection device in the one or more collection devices does not match a data requirement of the second collection device in the current production flow. The first collection device and the second collection device each may be any collection device in the one or more collection devices, and the second collection device may be different from the first collection device.

Therefore, when any collection device of the vehicle does not collect data (for example, no data exists in the data channel of the collection device) or the collected data does not meet the data requirement of the current production flow, all the collection devices of the vehicle are controlled to stop the data collection, so that waste of resources and manpower due to a failure of one collection device or the data collected by one collection device is unavailable can be avoided. In another aspect, the collection and data analysis process are automatic, so that the dependency on the high-cost professional site and the professionals may also be reduced.

In some examples, the data collected by the second collection device does not match the data requirement of the second collection device in the current production flow, which may refer to that, for example, a structure of the data collected by the second collection device is different from a data structure of the data requirement of the second collection device in the current production flow, a field range of the data collected by the second collection device is inconsistent with a data field range of the data requirement of the second collection device in the current production flow, etc.

In some embodiments, for any collection device (such as the first collection device) in the one or more collection devices, when it is determined that controlling the one or more collection devices to stop the data collection is due to the first sub condition (i.e., the first collection device does not collect data), a first collection operation guidance corresponding to the first collection device may be acquired, and the one or more collection devices are controlled, based on the first collection operation guidance, to continue to perform the data collection. Thus, when any collection device fails, the collection device can be subject to operation guidance, so that all the collection devices can normally perform the data collection to improve the efficiency.

In some embodiments, for any collection device (such as the second collection device) in the one or more collection devices, when it is determined that controlling the one or more collection devices to stop the data collection is due to the second sub condition (i.e., the data collected by the second collection device does not match the data requirement of the second collection device in the current production flow), a second collection operation guidance corresponding to the second collection device is acquired, and the one or more collection devices are controlled, based on the second collection operation guidance, to continue to perform the data collection. Thus, when the data collected by any collection device does not meet the requirement, the operation guidance can be performed on the collection device, so that the data collected by all the collection devices meets the requirement, thereby improving the validity of the collected data and the collection efficiency.

In some examples, for different production flows, the corresponding collection operation guidance may also be different. For the LiDAR-IMU calibration, a trajectory and a limit speed that an operator needs to drive may be displayed on a human machine interface (HMI) of the vehicle, and a residual trajectory that needs to be completed is displayed in real time. For the LiDAR-camera calibration, a trajectory and a limit speed that an operator needs to drive and a collection completion progress may be displayed on the HMI.

In some embodiments, under the condition that the data collected by the collection devices meets the requirement, the collected data may also be preprocessed, and the preprocessed data is uploaded to a cloud. In some examples, the preprocessed data may be used to perform service configuration of the vehicle in the cloud. By means of the service configuration in the cloud, separation of a technology from a use operation can be realized, which is conductive to large-scale technology servitization. In some examples, preprocessing the collected data may include performing validity verification and state verification on the collected data.

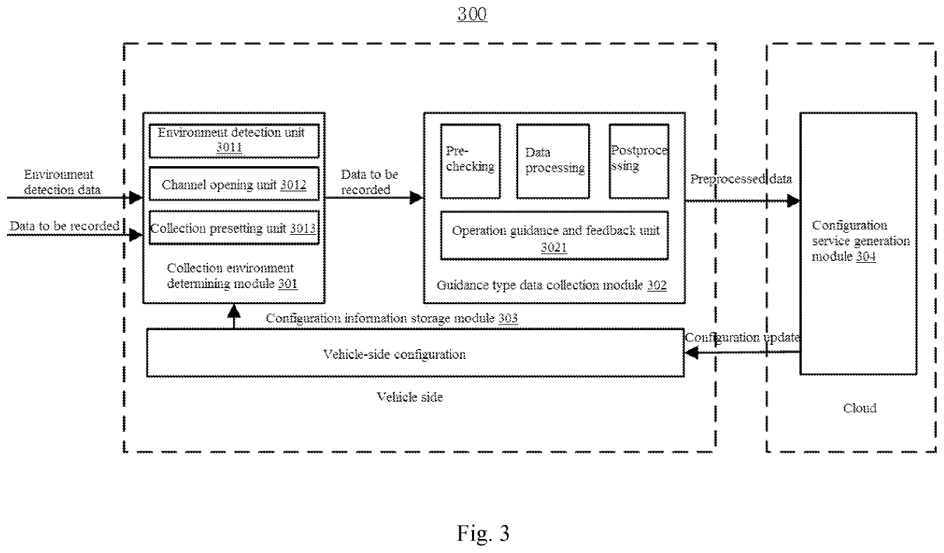

According to some embodiments of the present disclosure, an environment collection and configuration generation system is further provided. FIG. 3 illustrates a schematic diagram of an environment collection and configuration generation system 300 according to the embodiments of the present disclosure. The system 300 is composed of a vehicle-side part and a cloud part. The vehicle-side part includes a collection environment determining module 301, a guidance type data collection module 302, and a configuration information storage module 303. The cloud part includes a configuration service generation module 304.

The collection environment determining module 301 is configured to determine, according to vehicle configuration information, external environment information (such as collected environmental data) and a current production flow (such as vehicle calibration, sensing device calibration and map collection), whether data collection is performed in a current environment. The collection environment determining module 301 includes an environment detection unit 3011, a channel opening unit 3012 and a collection presetting unit 3013.

The environment detection unit 3011 is configured to analyze environment detection data to determine whether the current environment meets a collection need.

The channel opening unit 3012 is configured to open a corresponding data channel to be recorded according to the current production flow and ensures that channel data is normal (for example, whether the channel has data, and whether a data structure and a data field range meet expectations). For example, for the LiDAR-IMU calibration, an integrated inertial navigation device and its corresponding data channel, a positioning module and its corresponding data channel, a LiDAR device and its corresponding data channel, etc. are turned on.

The collection presetting unit 3013 is configured to pre-determine a collector configuration parameter to be invoked according to the vehicle configuration information. For example, under the condition that the configuration information storage module 303 stores a sensing device solution configuration, a parameter table format needing to be calibrated may be determined based on the sensing device solution configuration during sensing device calibration.

The guidance type data collection module 302 is configured to perform pre-checking, data processing, post-checking, etc. on data to be recorded. The guidance type data collection module 302 includes an operation guidance and feedback unit 3021.

The pre-check flow includes performing pre-checking on a data channel to be recorded required by the current production flow (for example, whether the channel has data, and whether a data structure and a data field range meet expectations). When the data is normal, data collection is continued to be performed; and when the data is abnormal, a prompt is displayed on the HMI, and the data collection is stopped. The data processing flow includes preprocessing the recorded data to extract data to be used by the cloud. The postprocessing flow includes performing validity verification and state verification on the processed data obtained by the data processing flow.

The operation guidance and feedback unit 3021 is configured to guide, based on feedbacks of the pre-checking and postprocessing flows, an operator to operate the vehicle in real time to complete the data collection.

The configuration service generation module 304 is configured to read the preprocessed data to complete the configuration generation.

Thus, the dependency on references in a collection process can be reduced by means of environment detection, channel opening, collection presetting, etc. By means of the guidance type data collection, the validity of the collected data and the collection efficiency can be improved.

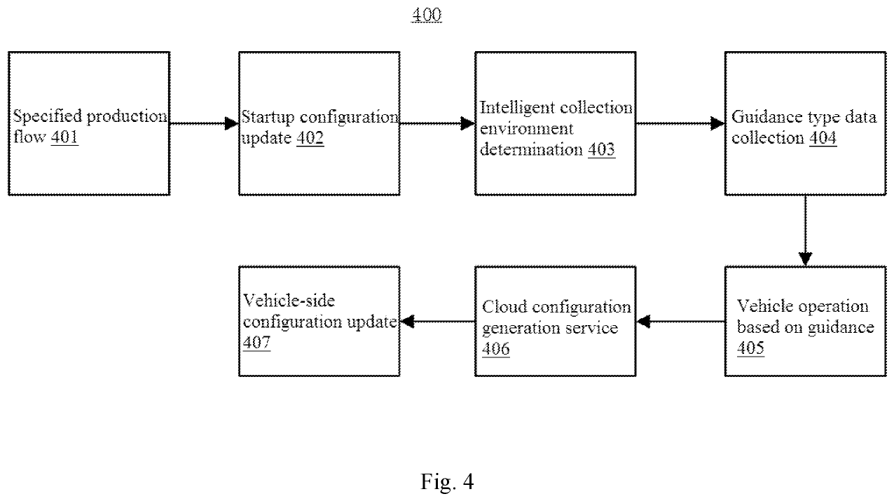

FIG. 4 illustrates a schematic flowchart of an environment collection and configuration generation method 400 according to the embodiments of the present disclosure. As shown in FIG. 4, the method 400 may include the following flows: a specified production flow (step 401), startup configuration update information (step 402), intelligent collection environment determination (step 403), guidance type data collection (step 404), vehicle operation based on guidance (step 405), cloud configuration generation service (step 406), and vehicle-side configuration update (step 407).

The method according to the example embodiments of the present disclosure is described above. Although the various operations are depicted in a specific order in the drawings, this should not be understood as requiring that these operations must be performed in the specific order shown or in an antegrade order, nor should it be understood as requiring that all shown operations must be performed to obtain a desired result.

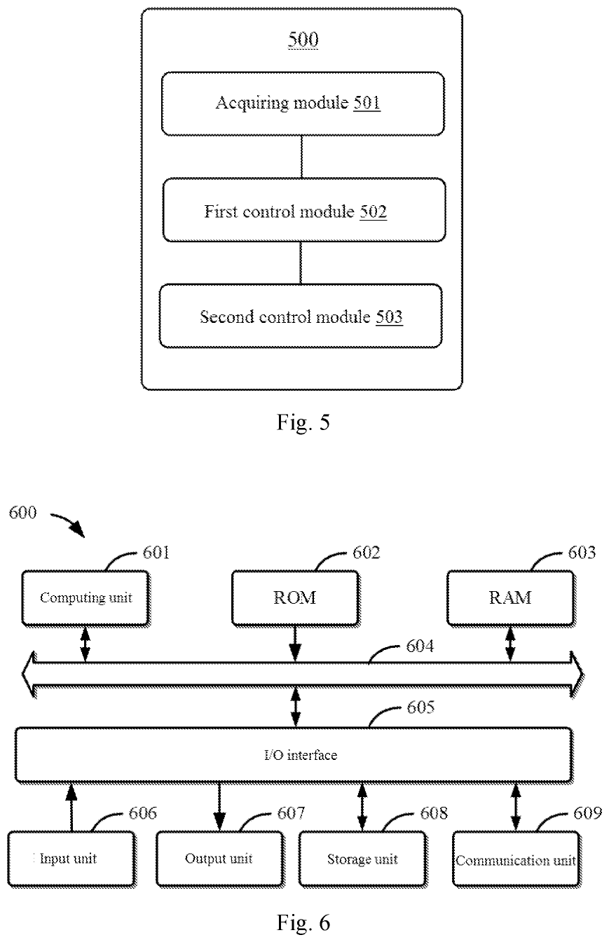

FIG. 5 illustrates a structural block diagram of an apparatus 500 for controlling data collection according to the embodiments of the present disclosure. As shown in FIG. 5, the apparatus 500 includes an acquiring module 501, a first control module 502, and a second control module 503.

The acquiring module 501 is configured to acquire environmental data of a current environment where a vehicle is located.

The first control module 502 is configured to control, according to a current production flow of the vehicle, one or more collection devices of the vehicle to perform data collection in response to determining, according to the environmental data, that the current environment meets an environment collection requirement.

In some embodiments, the one or more collection devices correspond to the current production flow.

The second control module 503 is configured to control the data collection of the one or more collection devices based on the data collection situation of the one or more collection devices.

In some examples, operations of the acquiring module 501, the first control module 502, and the second control module 503 respectively correspond to the steps 201 to 203 of the method 200 described in FIG. 2, so that detailed descriptions thereof are omitted here.

Although specific functions have been discussed above with reference to specific modules, it should be noted that the functions of each module discussed herein may be divided into multiple modules, and/or at least some functions of the multiple modules may be combined into a single module. The specific module performing an action discussed herein includes the specific module itself performing the action, or alternatively the specific module calling or otherwise accessing another component or module that performs the action (or performs the action in combination with the specific module). Therefore, a specific module that performs an action may include the specific module itself that performs the action and/or another module that is called or otherwise accessed by the specific module and performs the action.

Example embodiments of the present disclosure further provide an electronic device, including at least one processor and a memory in communication connection with the at least one processor. The memory stores a computer program that can be executed by the at least one processor. The computer program, when executed by the at least one processor, is configured to cause the electronic device to implement the method according to the embodiments of the present disclosure.

Example embodiments of the present disclosure further provide a non-transient computer-readable storage medium that stores a computer program. The computer program, when executed by a processor of a computer, is configured to cause the computer to implement the method according to the embodiments of the present disclosure.

Example embodiments of the present disclosure further provide a computer program product including a computer program. The computer program, when executed by a processor of a computer, is configured to cause the computer to implement the method according to the embodiments of the present disclosure.

Referring to FIG. 6, a structural block diagram of an electronic device 600 that can be used as a server or client of the present disclosure is described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may also represent various forms of mobile devices, such as personal digital processing, a cellular phone, a smart phone, a wearable device, and other similar computing devices. The components shown herein, their connections and relationships, and their functions are merely examples, and are not intended to limit the implementation of the present disclosure described and/or required herein.

As shown in FIG. 6, the device 600 includes a computing unit 601, which can execute various appropriate actions and processing according to computer programs that are stored in a read-only memory (ROM) 602 or computer programs loaded from a storage unit 608 into a random access memory (RAM) 603. Various programs and data required for operations of the device 600 are also stored in the RAM 603. The computing unit 601, the ROM 602, and the RAM 603 are connected to each other by means of a bus 604. An input/output (I/O) interface 605 is also connected to the bus 604.

Multiple components in the device 600 are connected to the I/O interface 605, including: an input unit 606, an output unit 607, a storage unit 608, and a communication unit 609. The input unit 606 can be any type of device that can input information to the device 600. The input unit 606 can receive input numeric or character information and generate key signal inputs that are related to user settings and/or function control of the electronic device, and may include, but is not limited to, a mouse, a keyboard, a touch screen, a trackpad, a trackball, a joystick, a microphone, and/or a remote controller. The output unit 607 may be any type of device that can present information, and may include, but is not limited to, a display, a speaker, a video/audio output terminal, a vibrator, and/or a printer. The storage unit 608 may include, but is not limited to, a magnetic disk and an optical disk. The communication unit 609 allows the device 600 to exchange information/data with other devices through a computer network such as the Internet and/or various telecommunication networks, and may include, but is not limited to, a modem, a network card, an infrared communication device, a wireless communication transceiver, and/or a chipset, such as a Bluetooth™ device, an 802.11 device, a Wi-Fi device, a WiMAX device, a cellular communication device and/or analogues.

The computing unit 601 may be various general-purpose and/or special-purpose processing components with processing and computing capabilities. Some examples of the computing unit 601 include, but are not limited to, a central processing unit (CPU), a graphics processing unit (GPU), various dedicated artificial intelligence (AI) computing chips, various computing units that run machine learning model algorithms, a digital signal processing (DSP), and any appropriate processor, controller, microcontroller, etc. The computing unit 601 executes the various methods and processes described above, for example, the method 200. For example, in some embodiments, the method 200 may be implemented as a computer software program, which is tangibly contained in a machine-readable medium, such as the storage unit 608. In some embodiments, part or all of the computer programs may be loaded and/or installed on the device 600 via the ROM 602 and/or the communication unit 609. When the computer program is loaded to the RAM 603 and executed by the computing unit 601, one or more steps of the method 200 described above can be executed. Alternatively, in other embodiments, the computing unit 601 may be configured to execute the method 200 in any other suitable manner (for example, by means of firmware).

Various implementation modes of the systems and technologies described herein can be implemented in a digital electronic circuit system, an integrated circuit system, a field programmable gate array (FPGA), an application specific integrated circuit (ASIC), an application-specific standard product (ASSP), a system-on-chip (SOC), a complex programmable logic device (CPLD), computer hardware, firmware, software, and/or their combination. These various implementation modes may include: being implemented in one or more computer programs. The one or more computer programs may be executed and/or interpreted on a programmable system including at least one programmable processor. The programmable processor may be a dedicated or general-purpose programmable processor that can receive data and instructions from the storage system, at least one input device, and at least one output device, and transmit the data and instructions to the storage system, the at least one input device, and the at least one output device.

Program codes used to implement the method of the present disclosure can be written in any combination of one or more programming languages. These program codes can be provided to processors or controllers of general-purpose computers, special-purpose computers, or other programmable data processing apparatuses, so that when the program codes are executed by the processors or controllers, the functions/operations specified in the flowcharts and/or block diagrams are implemented. The program codes can be entirely or partly executed on a machine, partly executed on the machine as an independent software package, and partly executed on a remote machine, or entirely executed on the remote machine or a server.

In the context of the present disclosure, a machine-readable medium may be a tangible medium, which may contain or store a program for use by an instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer disk, a hard disk, an RAM, an ROM, an erasable programmable read-only memory (EPROM or a flash memory), an optical fiber, a portable compact disk read-only memory (CD-ROM), an optical storage device, a magnetic storage device, or any suitable combination of the above.

In order to provide interaction with users, the systems and techniques described herein can be implemented on a computer that has: a display apparatus for displaying information to the users (for example, a cathode ray tube (CRT) or a liquid crystal display (LCD) monitor); and a keyboard and a pointing apparatus (such as a mouse or a trackball) through which the users can provide inputs to the computer. Other types of devices can also be used to provide interaction with the users. For example, a feedback provided to the users can be any form of sensory feedback (for example, visual feedback, auditory feedback, or tactile feedback), and the inputs from the users can be received in any form (including sound input, speech input, or tactile input).

The systems and technologies described herein can be implemented in a computing system that includes a background component (for example, as a data server), or a computing system that includes a middleware component (for example, an application server), or a computing system that includes a front-end component (for example, a user computer with a graphical user interface or web browser through which the user can interact with the implementation modes of the systems and technologies described herein), or a computing system that includes any combination of the background component, the middleware component, or the front-end component. The components of the system can be connected to each other through any form or medium of digital data communication (for example, a communication network). Examples of the communication network include: a local area network (LAN), a wide area network (WAN), and an Internet.

The computer system can include clients and servers. The client and the server are generally far away from each other and usually interact through a communication network. A relationship between the client and the server is generated by computer programs running on corresponding computers and having a client-server relationship with each other.

It should be understood that the various forms of flows shown above can be used to reorder, add or delete steps. For example, the steps described in the present disclosure may be executed in parallel, sequentially or in a different order, as long as the desired results of the technical solutions disclosed in the present disclosure can be achieved, which is not limited herein.

Although the embodiments or examples of the present disclosure have been described with reference to the accompanying drawings, it should be understood that the above-mentioned methods, systems, and devices are merely illustrative embodiments or examples, and the scope of the present disclosure is not limited by these embodiments or examples, and is only limited by the authorized claims and their equivalent scopes. Various elements in the embodiments or examples may be omitted or replaced by equivalent elements. In addition, all the steps may be performed in an order different from that described in the present disclosure. Further, various elements in the embodiments or examples can be combined in various ways. What is important is that as technology evolves, many elements described herein can be replaced by equivalent elements that appear after the present disclosure.

What is claimed is:

1. A method, comprising:
acquiring environmental data of a current environment in which a vehicle is located;
determining, according to the environmental data, that the current environment meets an environment collection requirement;
in response to the determining, controlling one or more collection devices of the vehicle to perform data collection according to a current production flow of the vehicle, wherein the one or more collection devices correspond to the current production flow; and
controlling the data collection of the one or more collection devices based on a data collection situation of the one or more collection devices.

2. The method according to claim 1, wherein controlling the data collection comprises:
in response to determining that the data collection situation of the one or more collection devices meets a condition, controlling the one or more collection devices to stop the data collection,
wherein the condition comprises at least one of:
a first sub condition in which a first collection device in the one or more collection devices does not collect data, wherein the first collection device is any collection device in the one or more collection devices; or
a second sub condition in which data collected by a second collection device in the one or more collection devices does not match a data requirement of the second collection device in the current production flow, wherein the second collection device is any collection device in the one or more collection devices.

3. The method according to claim 2, wherein the condition comprises the first sub condition, the method further comprising:
acquiring a first collection operation guidance corresponding to the first collection device; and
controlling, based on the first collection operation guidance, the one or more collection devices to continue to perform the data collection.

4. The method according to claim 2, wherein the condition comprises the second sub condition, the method further comprising:
acquiring a second collection operation guidance corresponding to the second collection device; and
controlling, based on the second collection operation guidance, the one or more collection devices to continue to perform the data collection.

5. The method according to claim 4, further comprising:
after controlling the one or more collection devices to continue to perform the data collection, in response to determining that the data collected by the second collection device matches the data requirement of the second collection device in the current production flow, preprocessing the data collected by the one or more collection devices to generate preprocessed data; and
uploading the preprocessed data to a server, wherein the preprocessed data is used to perform service configuration of the vehicle.

6. The method according to claim 1, further comprising:
acquiring configuration information of the vehicle; and
determining whether the current environment meets the environment collection requirement based on the configuration information, the current production flow, and the environmental data.

7. The method according to claim 1, wherein the current production flow comprises one or more of: vehicle calibration, vehicle sensing device calibration, or vehicle map collection.

8. An electronic device, comprising:
a processor; and
a memory communicatively connected to the processor, wherein the memory stores a computer program executable by the processor, wherein the computer program, when executed by the processor, is configured to cause the electronic device to perform operations comprising:
acquiring environmental data of a current environment in which a vehicle is located;
determining, according to the environmental data, that the current environment meets an environment collection requirement;
in response to the determining, controlling one or more collection devices of the vehicle to perform data collection according to a current production flow of the vehicle, wherein the one or more collection devices correspond to the current production flow; and
controlling the data collection of the one or more collection devices based on a data collection situation of the one or more collection devices.

9. The electronic device according to claim 8, wherein controlling the data collection comprises:
in response to determining that the data collection situation of the one or more collection devices meets a condition, controlling the one or more collection devices to stop the data collection,
wherein the condition comprises at least one of:
a first sub condition in which a first collection device in the one or more collection devices does not collect data, wherein the first collection device is any collection device in the one or more collection devices; or
a second sub condition in which data collected by a second collection device in the one or more collection devices does not match a data requirement of the second collection device in the current production flow, wherein the second collection device is any collection device in the one or more collection devices.

10. The electronic device according to claim 9, wherein the condition comprises the first sub condition, and wherein the operations further comprise:
acquiring a first collection operation guidance corresponding to the first collection device; and
controlling, based on the first collection operation guidance, the one or more collection devices to continue to perform the data collection.

11. The electronic device according to claim 9, wherein the condition comprises the second sub condition, and wherein the operations further comprise:
acquiring a second collection operation guidance corresponding to the second collection device; and
controlling, based on the second collection operation guidance, the one or more collection devices to continue to perform the data collection.

12. The electronic device according to claim 11, wherein the operations further comprise:
after controlling the one or more collection devices to continue to perform the data collection, in response to determining that the data collected by the second collection device matches the data requirement of the second collection device in the current production flow, preprocessing the data collected by the one or more collection devices to generate preprocessed data; and
uploading the preprocessed data to a server, wherein the preprocessed data is used to perform service configuration of the vehicle.

13. The electronic device according to claim 8, wherein the operations further comprise:
acquiring configuration information of the vehicle; and
determining whether the current environment meets the environment collection requirement based on the configuration information, the current production flow, and the environmental data.

14. The electronic device according to claim 8, wherein the current production flow comprises one or more of: vehicle calibration, vehicle sensing device calibration, or vehicle map collection.

15. A non-transitory computer-readable storage medium storing a computer program that, when executed by a processor of a computer, causes the computer to perform operations comprising:
acquiring environmental data of a current environment in which a vehicle is located;
determining, according to the environmental data, that the current environment meets an environment collection requirement;
in response to the determining, controlling one or more collection devices of the vehicle to perform data collection according to a current production flow of the vehicle, wherein the one or more collection devices correspond to the current production flow; and
controlling the data collection of the one or more collection devices based on a data collection situation of the one or more collection devices.

16. The storage medium according to claim 15, wherein controlling the data collection comprises:
in response to determining that the data collection situation of the one or more collection devices meets a condition, controlling the one or more collection devices to stop the data collection,
wherein the condition comprises at least one of:
a first sub condition in which a first collection device in the one or more collection devices does not collect data, wherein the first collection device is any collection device in the one or more collection devices; or
a second sub condition in which data collected by a second collection device in the one or more collection devices does not match a data requirement of the second collection device in the current production flow, wherein the second collection device is any collection device in the one or more collection devices.

17. The storage medium according to claim 16, wherein the condition comprises the first sub condition, and wherein the operations further comprise:
acquiring a first collection operation guidance corresponding to the first collection device; and
controlling, based on the first collection operation guidance, the one or more collection devices to continue to perform the data collection.

18. The storage medium according to claim 16, wherein the condition comprises the second sub condition, and wherein the operations further comprise:
acquiring a second collection operation guidance corresponding to the second collection device; and
controlling, based on the second collection operation guidance, the one or more collection devices to continue to perform the data collection.

19. The storage medium according to claim 18, wherein the operations further comprise:
after controlling the one or more collection devices to continue to perform the data collection, in response to determining that the data collected by the second collection device matches the data requirement of the second collection device in the current production flow, preprocessing the data collected by the one or more collection devices to generate preprocessed data; and
uploading the preprocessed data to a server, wherein the preprocessed data is used to perform service configuration of the vehicle.

20. The storage medium according to claim 15, wherein the operations further comprise:
acquiring configuration information of the vehicle; and
determining whether the current environment meets the environment collection requirement based on the configuration information, the current production flow, and the environmental data.
